(19) United States
(12) Patent Application Publication
(10) Pub. No.: US 2003/0208357 A1
(43) Pub. Date: Nov. 6, 2003

(54) First aid kit instructions

(75) Inventor: David A. Hammond, Tinton Falls, NJ (US)

Correspondence Address: GARDNER CARTON & DOUGLAS LLP, 191 N. WACKER DRIVE, SUITE 3700, CHICAGO, IL, 60606, US

(73) Assignee: DLH, Inc., Tinton Falls, NJ

(21) Appl. No.: 10/140,462

(22) Filed: May 6, 2002

(51) Int. Cl. G10L 21/00

(52) U.S. Cl. 704/270

(57) ABSTRACT

An instructional card for a first aid kit that gives instructions for administering first aid by audio means, visual means, written means, graphical means or a combination of means thereof. The instructional card may be identified as corresponding to a pack of first aid supplies to be used to administer the first aid treatment as instructed by the instructional card. Alternatively, the instructional card may be included inside the pack of first aid supplies that are to be used to administer the first aid treatment described by the instructional card.

### FIELD OF THE INVENTION

The present invention relates to first aid kits, in particular, to the instructions that accompany first aid supplies.

### BACKGROUND OF THE INVENTION

Proper administration of first aid can reduce the fatality rate from accidents, decrease costs to all consumers of health care services and decrease recovery time of the injured person. According to a National Center for Injury Prevention and Control Injury Statistics compilation report of 2000, accidental injuries kill more Americans between the ages of one and 44 years old than any other cause of death. Accidents continue to be the fifth leading cause of death in all age groups, exceeded by heart disease, cancer, stroke, and chronic pulmonary disease. The economic impact of fatal accidents in the year 2000 amounted to $512.4 Billion. This cost is equivalent to about $1,900 per capita, or about $5,000 per household. This cost is paid by every individual or household either directly, out-of-pocket, or through higher prices for goods and services, or higher taxes.

The Occupational Safety and Health Administration (“OSHA”) requires that all employers provide first aid personnel and supplies. OSHA does not specify the exact nature of the supplies or the exact contents of a first aid kit. However, according to a National Hospital Ambulatory Medical Care Survey, 29% of all injuries resulting in emergency department visits occurred at home, and the home is the most common place for all accidental injuries.

According to the American Red Cross, people who have taken first aid classes may not remember what to do in an emergency situation. Their studies have shown that the retention rate of the skills covered in a first aid class drops after six weeks and is gone in six months. If first aid supplies are available at the scene of an accident, it is likely that a potential administrator of first aid will not know how to use the supplies and may use the supplies incorrectly, thereby causing additional harm or injury. Coupled with the fact that retention of skills is lost fairly quickly, is the fact that there are no existing testing or performance standards for consumer first aid kits.

Of the first aid kits currently available, there are few that contain concise instructions on the treatment of a particular injury. Where instructions exist within a first aid kit they are of little use to the illiterate or individuals who may not read the language of the instructions. Additionally, in the context of an emergency, it is difficult to predict the ability of a first aid kit user to calmly search for, read, understand and apply written instructions.

There is a need for a first aid kit to contain concise, easy to follow instructions on treating first aid situations. There is further a need for the instructions to be given by audio means, video means, or both. Such a kit would be advantageous in environments in which a variety of languages are fluently understood and/or conditions make it difficult to read written instructions. Such a kit would facilitate a calm approach to an emergency situation and result in better first aid treatment being administered to an injured person.

### SUMMARY OF THE INVENTION

Embodiments of the present invention provide a first aid kit with instructional cards for a wide variety of different types of first aid situations. The instructional cards include audio or video instructions, or both coordinated in time, that instruct the user, step-by-step, on how to treat a particular first aid situation. The audio and/or video instructional card may accompany, or be packaged with, a first aid pack within a kit that contains the supplies needed to treat the first aid situation described by the instructional card.

In one embodiment, the instructional card contains a voice module activated by a switch. Activation of the switch turns on power to a processor. The processor accesses a memory chip that contains a digitized voice recording of instructions. The audio signal is sent to a speaker and the user will hear the instructions. The instructional card may also contain a video display component where a digitized video component is accessed from the memory chip and the video feed sent to the display component. The user can view the visual instructions regarding the use of the supplies in the first aid kit. The instructional card may contain one or both of the audio module and video display component.

The instructional card may be made of a substrate that houses the switch, circuit board, power supply, speaker, visual display component and connectors. The substrate and components are contained within an envelope that has a window for the video display and openings to facilitate sound being emitted from the speaker to the user. The envelope may have a color-coded band to identify the instructions as corresponding to a particular pack of first aid supplies that are required for treatment of the situation. Use of a first aid kit of the present invention can increase the effectiveness of administering first aid whereby the user obtains the pack of supplies and corresponding audio and/or visual instructional card and listens to and/or views instructions on how to treat the first aid situation before administering treatment.

### BRIEF DESCRIPTION OF THE DRAWINGS

FIG. 1 is a perspective view of the instructional card of an embodiment of the present invention.

FIG. 2 is a circuit diagram of the components of the instructional card of FIG. 1 with one switch to activate both the audio module and video components.

FIG. 3 is a circuit diagram of the components of the instructional card of FIG. 1 with separate switches to allow the activation of the audio module and video components independently.

FIG. 4 is a flow diagram of the operational process of an instruction card of an embodiment of the present invention having audio and, optionally, video output.

FIG. 5 is a perspective view of the substrate contained within the envelope of the instructional card of FIG. 1 and components affixed to the substrate.

FIG. 6 is an exploded view of the contents of an exemplary first aid kit that include the instructional card of an embodiment of the present invention.

FIG. 6a depicts a first aid supply pack containing the instructional card of an embodiment of the present invention.

FIG. 6b depicts a first aid supply pack with a label and icon that corresponds to the label and icon on the instructional card displaying instructions that require the supplies in the pack according to the principle of the present invention.

### DETAILED DESCRIPTION OF THE INVENTION

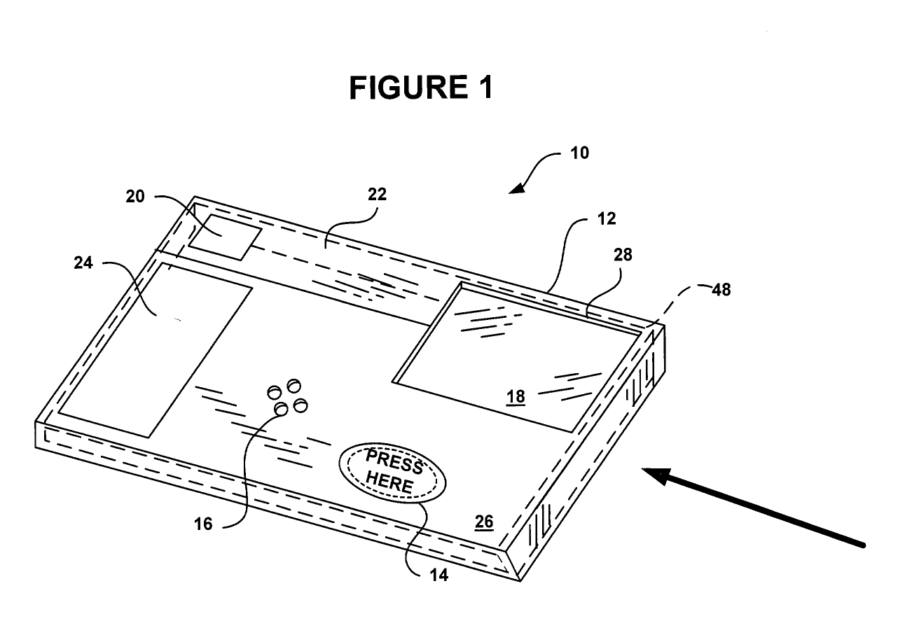

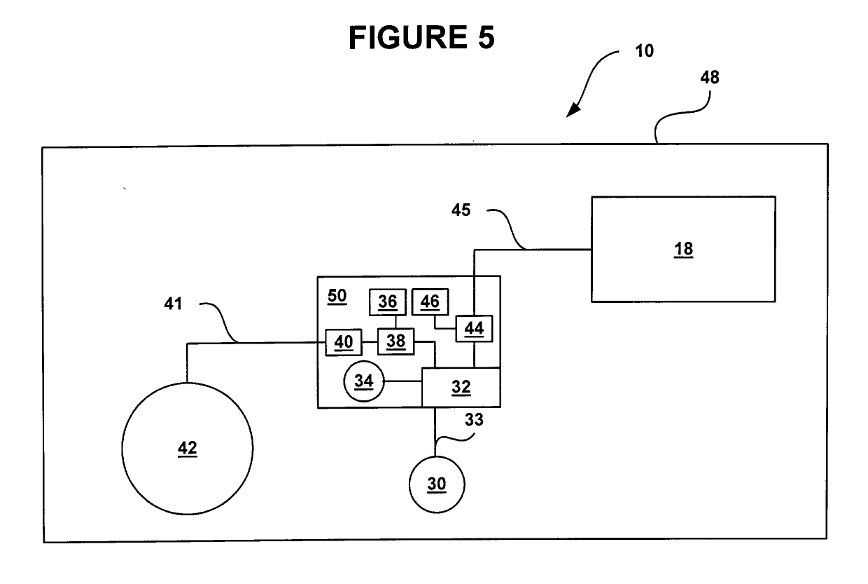

Referring to FIG. 1, a perspective view of the instructional card 10, shows an envelope 12 that contains the functional components (shown in FIG. 5) of the card. The envelope 12 may be an envelope, box, laminate or other appropriate container of the components of the instructional card 10. The instructional card 10 has a front 26 that indicates a button 14 to be depressed to activate the audio output and/or visual display features of the instructional card 10. The front 26 of the instructional card 10 contains a window 28 through which the user may view the video display unit 18. The front 26 of the instructional card 10 also has openings 16 to allow sound to be heard by the user when the audio components of the instructional card 10 are activated.

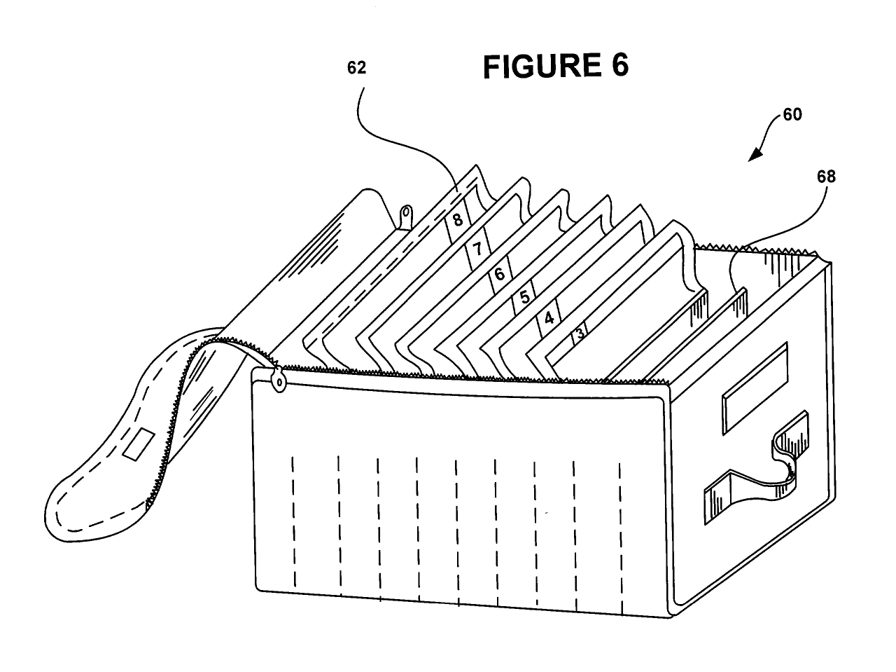

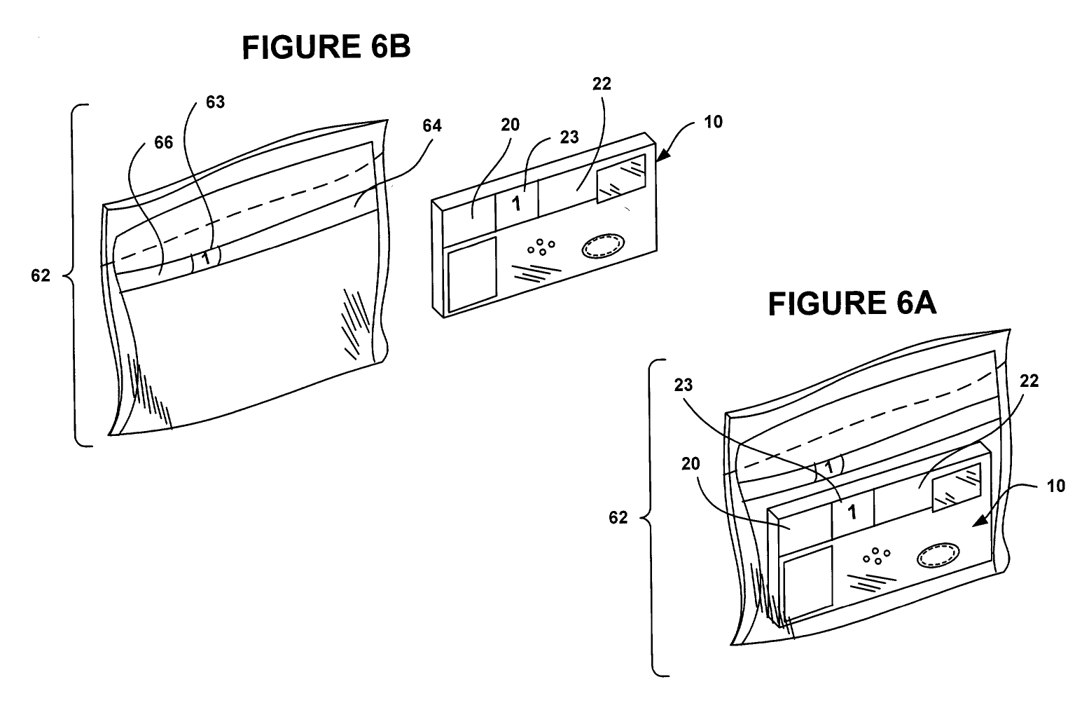

The instructional card 10 may display an icon 20 that indicates the particular first aid situation that will be addressed by that particular instructional card 10. A color-coded band 22 may also be placed on the instructional card 10. The color-coded band 22 will correspond to a color-coded pack of supplies (depicted in FIG. 6) that contains the supplies the user would need to administer the particular first aid situation addressed by the instructional card 10. Written instructions 24 that correspond to the audio and/or video instructions may also appear on the instructional card 10. The written instructions may also include instructions on the use of particular first aid supplies for treating the first aid situation, such supplies being contained in the packs of FIG. 6, and may further include graphical depictions of the first aid instructions to guide the administering of first aid to an injured person.

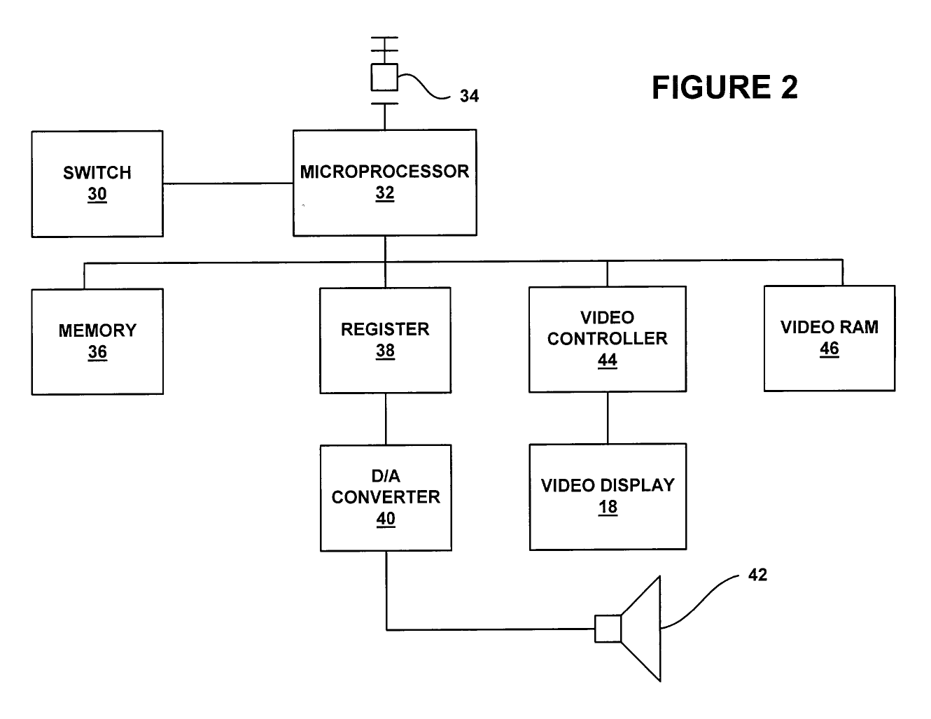

FIG. 2 is a circuit diagram of the components of the instructional card with one switch to activate both the audio output and video components. A switch 30, such as an interrupt switch for example, signals a processor 32 such as a microprocessor or a digital signal processor (DSP), that the button 14 (shown in FIG. 1) has been depressed. The microprocessor 32 is powered by a power source 34 that is typically a battery. Other power supplies known in the art may also be used with embodiments of the present invention. The microprocessor 32 accesses a memory chip 36 for a digitally stored sound file. The memory chip 36 also stores at least one program. Words of data from the digital sound file are fed through a register 38 to a digital-to-analog converter 40, which produces an analog audio signal that drives the associated speaker 42 to output sound.

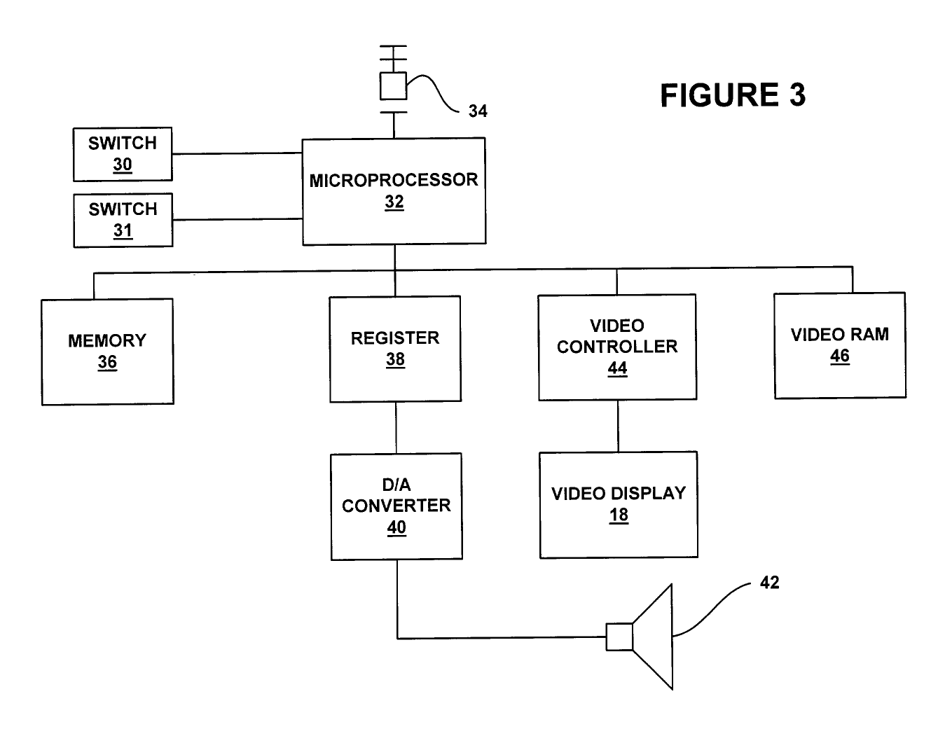

To activate the video instructions, the microprocessor 32 sends message data to a video controller 44 and the video controller 44 renders the message data into a video random access memory 46 (“RAM”) for output to the video display 18. Alternatively, the function of the video controller may be performed by the processor 32. FIG. 3 is the circuit diagram of FIG. 2 with a second switch 31 to allow separate signals to the processor to active the audio and visual components of the instructional card 10 separately.

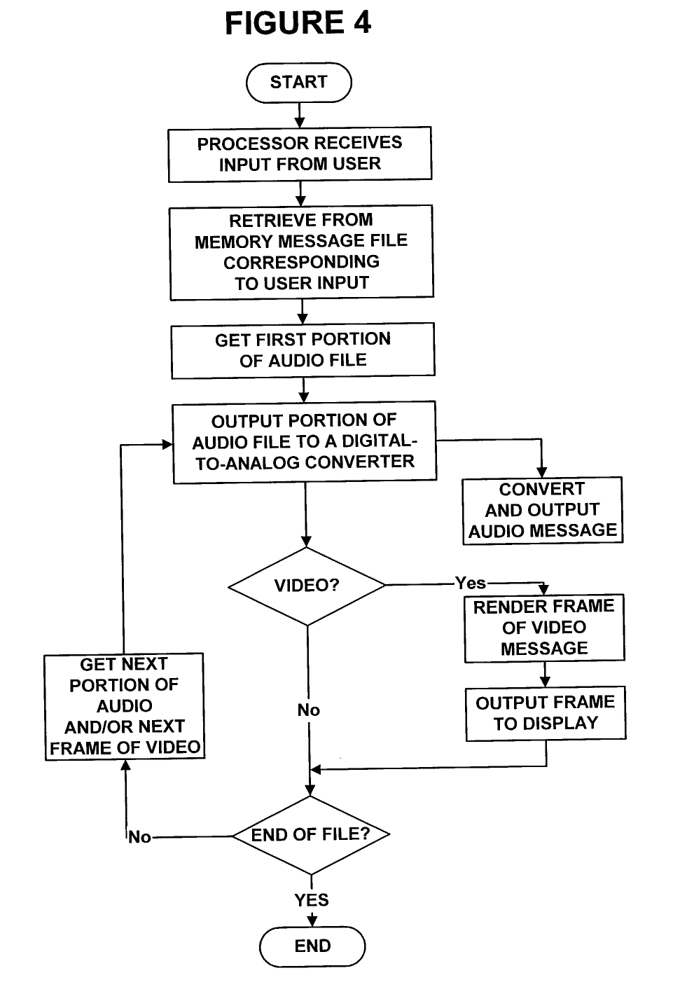

The operational process of the instructional card 10 having an audio and, optionally, video instructions or output. The audio and video instructions are coordinated in time so that specific words are outputted to the speaker 42 at the same time that a particular video frame is outputted to the video display 18. The operation diagramed in FIG. 4 begins when the processor receives input from the user. Input from the user is entered upon processor power up or upon interrupt caused by switch activation. The processor will retrieve from memory a message file corresponding to the user input. The processor will be directed, in the case of an instructional card having an audio output as in FIG. 4, to get a first portion of an audio file. The audio file will be sent to the digital-to-audio converter and subsequently converted for output from a speaker. Upon retrieving the portion of audio file, a first video frame or message will be rendered and sent to the video display. The retrieval and output of audio and, if available, video messages will continue until the files containing the audio and video messages no longer contains a next portion of audio or a next frame of video message.

FIG. 5 depicts the components of the instructional card 10 that are embedded in a substrate 48. The substrate may be foam, such as Styrofoam, or other foam or cushioning material of sufficient durability and flexibility to hold the components in place and prevent damage due to crushing or dropping of the instructional card 10. The switch 30 is held within the substrate 18 and connected to the microprocessor 32 on a circuit board 50 by a wire connection 33. The circuit board 50 supports the microprocessor 32, power supply 34, video controller 44, video ram 46, memory 36, register 38, and digital-to-analog converter 40. The video controller 44 on the circuit board 50 is connected to the video display 18 by a video wire 45. The speaker 42 is connected to the digital-to-analog converter 40 by a speaker wire 41. The instructional card 10 may be assembled to include only the audio components, or only the video components.

The instructional card 10 is included in a first aid kit 60, for example as depicted in FIG. 6. The instructional card 10 may be contained within a pack 62 of first aid supplies required to treat the first aid situation described on the instructional card 10 as depicted in FIG. 6a. Alternatively, as shown in FIG. 6b, the first aid supply pack 62 may display a color-coded band 64 and/or icon 66 corresponding to the color-coded band 22 and icon 20 on the instructional card 10. The instructional card 10 and corresponding pack 62 may be numbered 23, 63 as well. The pack 62 containing the instructional card 10 of FIG. 6a may be placed within the first aid kit 60 sequentially. Alternatively, the pack 62 and separate corresponding instructional card 10 of FIG. 6b, may be arranged together in the first aid kit 10.

The first aid kit 60 contains a plurality of packs 62 as shown in FIG. 6. Each pack 62 contains the first aid supplies required to treat a particular first aid situation and the corresponding instructional card 10 includes instructions on how to administer first aid for that particular situation. The first aid situations for which a pack 62 and instructional card 10 are prepared may include breathing, bleeding, shock, head and spine, bone, eye, burn and bite injuries. The color-coded bands 22, 64 are unique and different for each pack 62. In cases were first aid may be administered for a particular situation and no first aid supplies are required, an instructional card 10 may be included in the first aid kit 60 without a corresponding pack. For example, an instructional card 10 may contain audio, video and written instructions for cardiopulmonary resuscitation (“CPR”) without a corresponding pack, or an instructional card 10 describing treatment of a person who ingested a poison may not have a corresponding pack. The plurality of packs 62 may be arranged within a plurality of compartments 68 within the first aid kit 60 or otherwise sequentially arranged for a card catalogue/filing cabinet effect.

It should be understood that various changes and modifications preferred in the embodiment described herein will be apparent to those skilled in the art. Such changes and modifications can be made without departing from the spirit and scope of the present invention and without demising its attendant advantages. It is therefore intended that such changes and modifications be covered by the appended claims.

What is claimed is:

1. A first aid system comprising an instructional card having an audio instruction of a first aid treatment for a particular first aid situation, the audio instruction activated by a switch located in the card.

2. The system of claim 1 further comprising a pack corresponding to the instructional card, the pack containing first aid supplies required to treat the particular first aid situation instructed by the card.

3. The instructional card of claim 2 wherein the pack and the corresponding instructional card are coordinated by an identification selected from the group consisting of a commonly colored band, a common icon and a common number.

4. The system of claim 1 further comprising written descriptions affixed to the card, the written description corresponding to the audio instruction of the card.

5. The system of claim 1 further comprising graphical depictions affixed to the card, the graphical depictions corresponding to the audio instruction of the card.

6. A first aid system comprising an instructional card having a video instruction of a first aid treatment for a particular first aid situation, the video instruction activated by a switch located in the card.

7. The system of claim 6 further comprising a pack corresponding to the instructional card, the pack containing first aid supplies required to treat the particular first aid situation instructed by the card.

8. The instructional card of claim 7 wherein the pack and the corresponding instructional card are coordinated by an identification selected from the group consisting of a commonly colored band, a common icon and a common number.

9. The system of claim 6 further comprising written descriptions affixed to the card, the written description corresponding to the video instruction of the card.

10. The system of claim 6 further comprising graphical depictions affixed to the card, the graphical depictions corresponding to the video instruction of the card.

11. A first aid system comprising an instructional card having an audio instruction and a video instruction of first a aid treatment for a particular first aid situation, the audio and video instructions activated by a switch located in the card.

12. The system of claim 11 further comprising a pack corresponding to the instructional card, the pack containing first aid supplies required to treat the particular first aid situation instructed by the card.

13. The instructional card of claim 12 wherein the pack and the corresponding instructional card are coordinated by an identification selected from the group consisting of a commonly colored band, a common icon and a common number.

14. The system of claim 11 further comprising written descriptions affixed to the card, the written description corresponds to the audio and video instructions of the card.

15. The system of claim 11 further comprising graphical depictions affixed to the card, the graphical depictions correspond to the audio and video instructions of the card.

16. A first aid kit comprising an instructional card having an audio instruction of a first aid treatment for a particular first aid situation.

17. The first aid kit of claim 16 further comprising a pack corresponding to the instructional card, the pack containing first aid supplies required to treat the particular first aid situation instructed by the card.

18. The instructional card of claim 17 wherein the pack and the corresponding instructional card are coordinated by an identification selected from the group consisting of a commonly colored band, a common icon and a common number.

19. A first aid kit comprising an instructional card having a video instruction of a first aid treatment for a particular first aid situation.

20. The first aid kit of claim 19, further comprising a pack corresponding to the instructional card, the pack containing first aid supplies required to treat the particular first aid situation instructed by the card.

21. The first aid kit of claim 20 wherein the pack and the corresponding instructional card are coordinated by an identification selected from the group consisting of a commonly colored band, a common icon and a common number.

22. A first aid kit comprising an instructional card having an audio instruction and a video instruction for a first aid treatment of a particular first aid situation.

23. The first aid kit of claim 22 further comprising a pack corresponding to the instructional card, the pack containing first aid supplies required to treat the particular first aid situation instructed by the card.

24. The first aid kit of claim 23 wherein the pack and the corresponding instructional card are coordinated by an identification selected from the group consisting of a commonly colored band, a common icon and a common number.

25. A method for imparting instructions for the treatment of a first aid situation during an emergency, the method comprising:
obtaining first aid supplies and an instructional card;
activating a switch on the instructional card; and
receiving instruction on the use of the supplies from the instructional card by listening to an audio instructional or by viewing a video instruction.
